(19) United States
(12) Patent Application Publication
(10) Pub. No.: US 2010/0309228 A1
(43) Pub. Date: Dec. 9, 2010

(54) Displaying Multi-Dimensional Data Using a Rotatable Object

(76) Inventors: Camilo Mattos, Los Angeles, CA (US); Joel Kraut, San Francisco, CA (US); Santiago Becerra, Del Mar, CA (US); David Becerra, Venice, CA (US); Patrick Cheng, San Diego, CA (US); Jaime Zuluaga, Encinitas, CA (US); Quinton Alsbury, Venice, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 12/478,752

(22) Filed: Jun. 4, 2009

(51) Int. Cl. G09G 5/00

(52) U.S. Cl. 345/654

(57) ABSTRACT

Effective display of data organized along multiple dimensions on a device having a display area that is small compared to the amount of data being shown in the chart is provided. A three-dimensional object that can be rotated along various axes of rotation is displayed in a particular orientation, displaying information related to a data point. Rotation of the object causes the object to be displayed in a different orientation thereby displaying information related to a different data point. The coordinates of the new data point displayed are determined based on the original coordinates and the direction and amount of rotation of the object. In one embodiment, a data arranged along two-dimensions is associated with a cube that can be rotated vertically or horizontally.

### BACKGROUND

1. Field of Art

The disclosure generally relates to displaying multi-dimensional data on a device having a display area that is small relative to the amount of data that is being displayed.

2. Description of the Related Art

Frequently there is need for displaying on a display screen of a computing device data represented in multiple dimensions, for example, multi-dimensional charts or graphs. On a mobile device such as a handheld device, handheld computer, cell phone, tablet computer, netbook, or personal digital assistant (PDA), such graphs and charts have to be displayed on small display screens. Due to limited display area, information related to either a single data point or a small subset of data points can only be displayed at a time. Users are allowed to inspect various portions of the charts for example by using a scroll bar or by viewing the data a page at a time. Users navigate through the data using a pointing device or keys to move through the data set.

### SUMMARY

The present invention enables effective display of multi-dimensional data on a device having a display area that is small compared to the amount of data being shown. Examples of suitable devices include tablet computers, smart phone devices, and mobile phones. Some embodiments of the invention enable effective display of multi-dimensional data on devices with large display areas, for example, desktop computers. A simulated three-dimensional object that can be rotated along various axes of rotation is displayed in various orientations. The three-dimensional object can be rotated by user input, for example, a swiping motion of a pointing/selecting device in a particular direction or by tilting of the device. In one embodiment, the three dimensional object is a cube. Information related to a set of data points in the multi-dimensional data is displayed on a side (also referred to as a face) of the cube. As the cube is rotated to display another side, additional sets of data points are displayed. This allows the dimensionality of the data set to be explored intuitively, for example by vertical rotation of the cube displaying values along one dimension, and horizontal rotation displaying data along another dimension. In one embodiment, the amount of rotation of the cube determines the distance between the new data points displayed and the previously displayed data points. In other embodiments, other attributes of cube rotation, for example, the speed with which the user rotates the cube or the initial acceleration of the cube determines the distance between the new data points displayed and the previously displayed data points. The direction of rotation of the cube determines the order in which data points are displayed on successive faces. In some embodiments, audio feedback is provided as the cube is rotated. Although described as a “cube”, the displayed object is not restricted to six faces; the number of faces varies depending on the data set to be displayed. In one embodiment, when the last data set along the dimension has been displayed, the cube cannot be further rotated in that direction. Alternatively, the first data set may be displayed as the next displayed face.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates a cube displayed on a display screen of a device presenting multi-dimensional data.

FIG. 2 illustrates one embodiment of the architecture of a system for displaying data as charts.

FIG. 3 illustrates how a cube can be rotated horizontally towards left or right.

FIG. 4 illustrates how a cube can be rotated vertically upwards or downwards.

FIG. 5 illustrates how rotating a cube associates the cube with a different data point of a chart.

FIG. 6 illustrates how the cube can be rotated horizontally, causing the cube to display information associated with a data point with a different x-coordinate.

FIG. 7 illustrates how the cube can be rotated vertically causing the cube to display information associated with a data point with a different y-coordinate.

FIG. 8 shows a flowchart illustrating how user input determines rotation of the cube to display data associated with a chart.

FIG. 9 shows an embodiment displaying the chart data for a data point associated with the cube without displaying the cube.

FIG. 10 shows an alternate three-dimensional object that can be used to present three-dimensional data.

The Figures and the following description relate to various embodiments by way of illustration only. It should be noted that from the following discussion, alternative embodiments of the structures and methods disclosed herein will be readily recognized as viable alternatives that may be employed without departing from the principles of what is claimed.

### DETAILED DESCRIPTION

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

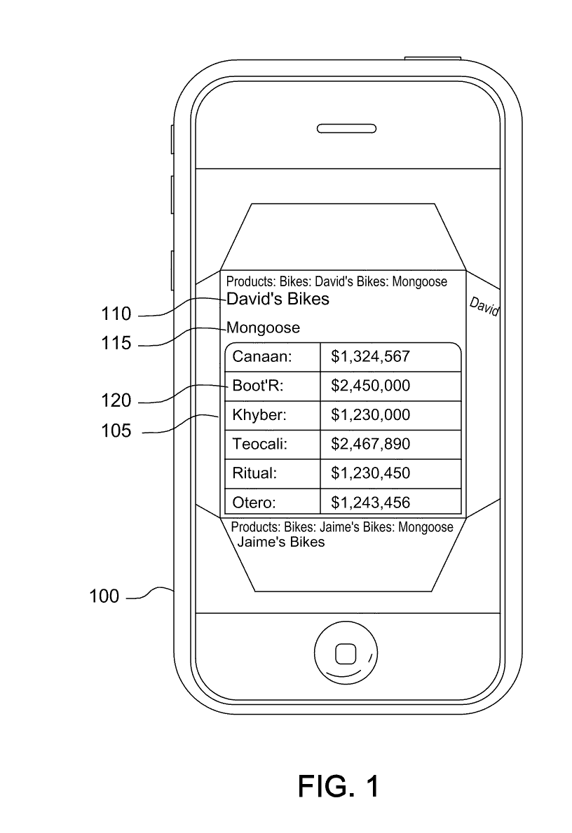

FIG. 1 illustrates a simulated cube 105 displaying information related to a data point of a two-dimensional chart on the display screen of a device 100. In some embodiments the information related to one or more data points can be displayed on a face of the cube. The underlying data of the example report associated with the chart displayed in FIG. 1 is represented using two dimensions, one dimension representing a sales person 110 and another dimension representing a bicycle brand 115. The detailed information 120 associated with each data point may represent sales information related to particular types of bicycles. The detailed information displayed can be either numeric data or other kind of data including images or alphanumeric data organized as multidimensional chart. In other embodiments, reports based on higher-dimensional data sets can be viewed using three dimensional objects that can be rotated along various axes of rotation.

In one embodiment, the two-dimensional chart is associated with a simulated cube that can be rotated vertically or horizontally. For example, horizontal rotation of the cube displaying information related to a particular set of coordinates (x1, y1) allows a user to view data points with different x-coordinates, keeping the y-coordinate constant at y1. Similarly vertical rotation allows a user to view information related to data points with different y-coordinates, keeping the x-coordinate constant at x1. In one embodiment, the amount of rotation of the cube determines the distance between the new data point displayed and the previously displayed data point. In other embodiments, other attributes of cube rotation, for example, the speed with which the user rotates the cube or the initial acceleration of the cube determines the distance between the new data point displayed and the previously displayed data point. The direction of rotation of the cube determines whether the new data point displayed is closer to or farther away from a point of origin of the axes compared to (x1, y1).

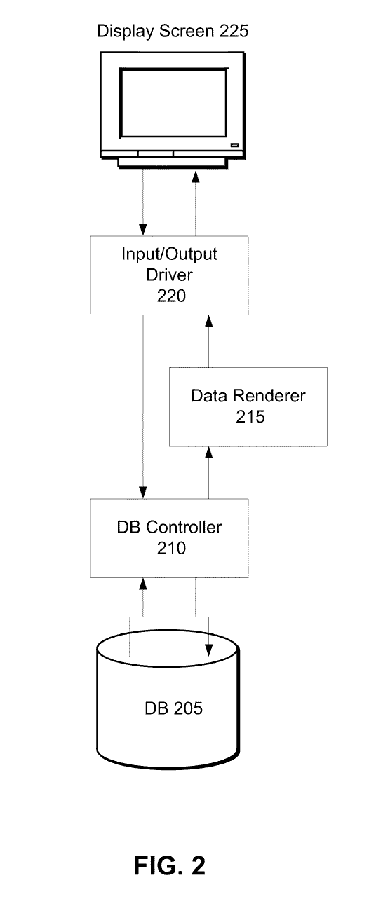

FIG. 2 is a block diagram of a system architecture in accordance with one embodiment. The components shown in FIG. 2 comprise a database (DB) 205, a DB controller module 210, a data renderer module 215, an input/output driver module 220 (also referred to as an IO driver module), and a display screen 225. Components such as the display screen 225 are hardware components whereas the DB controller 210 and the chart renderer 215 are software modules. As used herein, the term “module” refers to a computer program logic and/or data for providing the specified functionality. A module can be implemented in hardware, firmware, and/or software. Examples of types of computers that implement the system shown in FIG. 2 include tablet computers, smart phone devices, and mobile phones as well as devices with larger screens including desktop computers.

The DB 205 stores data and metadata associated with reports. The DB 205 in one embodiment is implemented using a hard disk drive but can also be implemented using any other device capable of storing data, such as a writeable compact disc (CD) or DVD, or a solid state memory device, for example a flash memory. The DB controller module 210 implements the logic to interface with the DB 205 so as to read data from the DB 205 or write data to the DB 205. The DB controller 210 provides data to the data renderer module 215 that computes information required for rendering the data. For example, the data renderer can determine the dimensions of a pie chart if the data needs to be displayed as a pie chart. The data and the information necessary for rendering the data are provided by the data renderer 215 to the input/output driver 220. The input/output driver 220 provides the display screen 225 with instructions and data necessary for displaying data and/or images. In various embodiments, the display screen 225 is used to input data and/or commands. For example, a touch sensitive screen can sense the coordinates of the portion of the screen touched by a user. The user may touch the display screen 225, for example, to select a command from a list of commands or to select a data element from a list of data elements displayed on the screen. In various embodiments, the display screen 225 can be tilted by the user. The magnitude and direction of tilt of the display screen 225 is detected and can be treated as an input. The angle of the tilt of the display screen is provided to the input/output driver 220 by hardware components such as an accelerometer. In some embodiments, a pointing device, such as a thumbwheel, mouse, track ball, or other type of pointing device is used to input data or commands into the system. The input/output driver 220 sends the data or instructions provided by the display screen 225 to the DB controller 210. The DB controller 210 in response to data or instructions received from the input/output driver 220 reads data from DB 205 and writes data to DB 205.

A mobile device may be used to view reports available to a user. The user may want to associate a particular report with a display mode, such as a pie chart, bar chart, or text mode. To allow the user to create an association between the report and a display mode, the user is presented with a list of display modes. The user may make a selection by touching the appropriate portion of the display screen 225 showing a specific mode of display, or by providing input through another mechanism such as a keyboard or pointing device. The DB controller 210 updates the metadata of the appropriate report in the DB 205 to store the information related to mode of display of the report. The information associating the report with a mode of display is used subsequently to display the report.

In another scenario, the user may be presented with a list of reports that can be reviewed. The user selects a particular report name and data renderer 215, computes information to render the data which is then displayed on display screen 225 in the specified format. Various other scenarios of interactions between the user and the various components and modules displayed in FIG. 2 are possible.

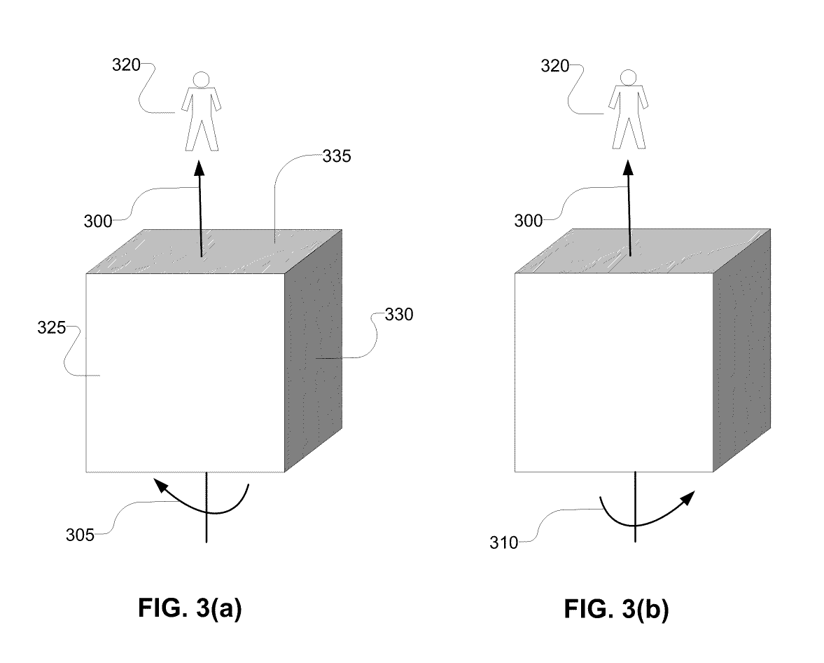

The display screen 225 displays the cube in a particular orientation and displays detailed information related to a data point associated with a set of coordinates. The cube can be rotated based on user input. The rotation of the cube causes the cube to display information related to another data point with a different set of coordinates. In some embodiments the detailed information related to the coordinates is displayed on the front face 325 of the cube shown in FIG. 3. The front face 325 of the cube is the face that is facing a user viewing the display screen and is considered occupying the front position. In some embodiments, the cube is shown in a perspective view, and information may be displayed on faces that are partially visible but not in the front, for example, the right face 330 or the top face 335. Rotation of the cube may cause the front face of the cube to move resulting in a different face occupying the front position. As a different face of the cube moves to the front position, the data point associated with the cube changes and so does the detailed information displayed on the cube.

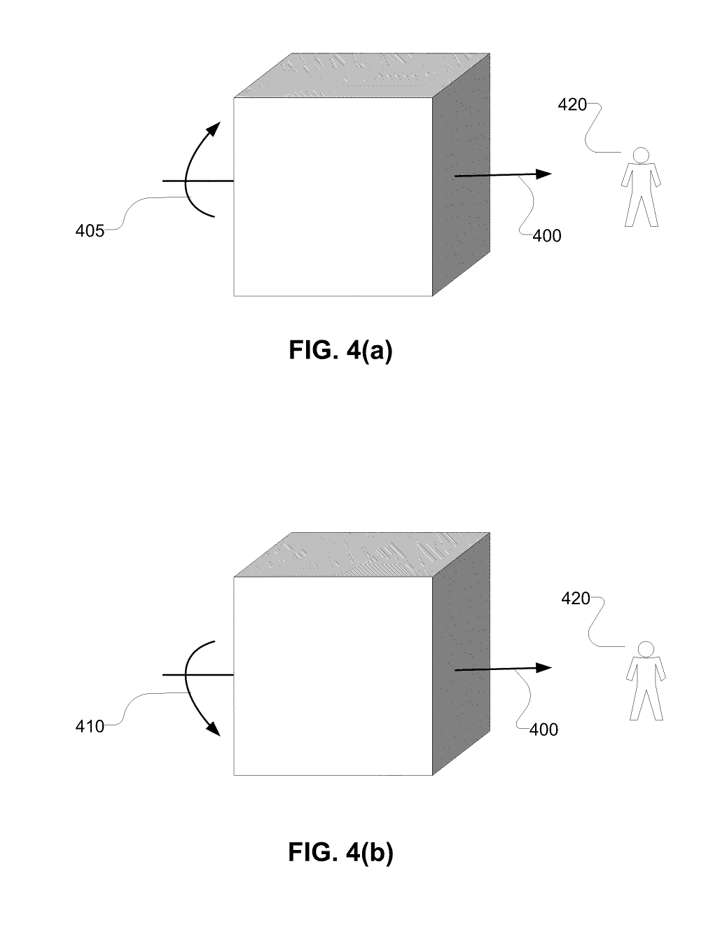

FIG. 3 and FIG. 4 show examples of directions in which a cube can be rotated. When the cube is rotated horizontally as shown in FIG. 3, the rotation is along a vertical axis 300 passing through the cube and can be clockwise 305 or counterclockwise 310 from the viewpoint of an observer 320 situated above the cube. A cube rotated horizontally clockwise from the viewpoint of observer 320 is considered rotated horizontally towards left. Similarly, a cube rotated horizontally counterclockwise from the viewpoint of observer 320 is considered rotated horizontally towards right. When the cube is rotated vertically as shown in FIG. 4, the rotation is along a horizontal axis 400 passing through the cube and can be clockwise 405 or counterclockwise 410 from the viewpoint of an observer 420 situated toward the right of the cube. A cube rotated vertically clockwise 405 from the viewpoint of the observer 420 is considered rotated vertically upwards. Similarly, a cube rotated vertically counterclockwise 410 from the viewpoint of the observer 420 is considered rotated vertically downwards.

The user input provided for rotating a cube can be, for example, a swiping motion of a pointing/selecting device pointing on the cube in a particular direction. In some embodiments, the pointing device can be the user's finger if the display screen 225 is touch-sensitive. The input provided by the user is detected by the input/output driver 220. The direction of swiping corresponds to the intended direction of rotation. The requested direction of rotation is checked by the input/output driver 220 and the cube rotated accordingly. In some embodiments, the initial speed of rotation of the cube is determined by the magnitude or the speed of the swiping motion. The cube is decelerated thereby causing it to stop and display information related to particular data points. In some embodiments, the cube can be rotated by tilting the display screen 225. The direction in which the cube rotates is determined by the angle of tilt. For example, the cube stays stationary in a particular orientation of the display screen called the neutral orientation but rotates in the same direction in which the display screen 225 is tilted. During rotation of the cube, if a desired data point is displayed on the screen, the user can tilt the display screen 225 back to the neutral orientation to view the data. In some embodiments, the speed of rotation of the cube is determined by the magnitude of the angle of tilt of the display screen 225. The user may start with a large angle of tilt to rotate faster in the beginning. The angle of tilt may be reduced as a desired data point gets closer. In some embodiments, the rotation of the cube results in audio feedback, for example, each time the information displayed on the cube is changed a sound is created. Hence, fast rotation of the cube results in a different sound effect compared to slow rotation.

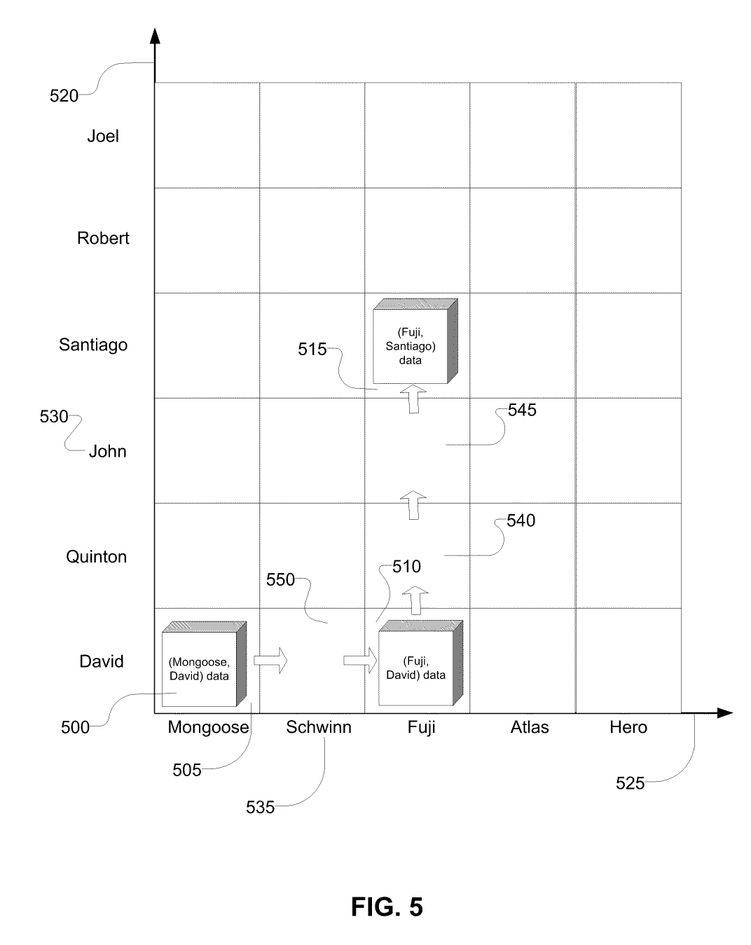

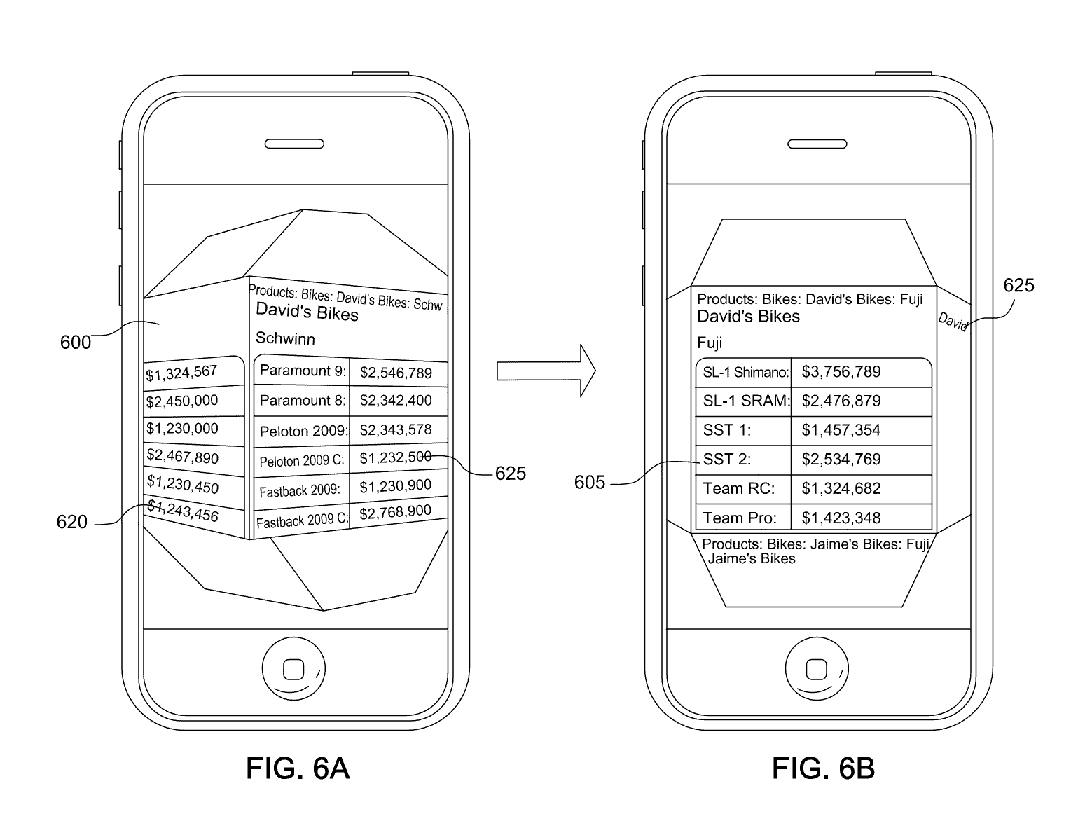

The cube can be used to inspect various kinds of data that can be arranged in a tabular form. For example, FIG. 5 illustrates how a cube can be used to inspect a two dimensional chart. In particular, FIG. 5 illustrates how rotation of a cube causes the cube to be associated with different coordinates of the chart. FIG. 5 shows an example chart displaying sample data associated with sales of bicycles as shown in FIG. 1. The chart shown in FIG. 5 is a two-dimensional chart with x-axis 525 based on various bicycle brands 535 and y-axis 520 based on names of sales persons 530. As shown in FIG. 5, initially, cube 500 is associated with the coordinates (Mongoose, David). Assume that the front face of the cube 500 displays information related to the data point 505 associated with coordinates (Mongoose, David), for example, as illustrated in FIG. 1. As shown, in FIG. 5, if the cube is rotated horizontally to the left, the cube displays data points with higher x-coordinate values. For example, a quarter of a rotation of the cube horizontally to the left causes the cube to display the data point (Schwinn, David) 550 with x-coordinate value one unit greater that data point 505. Similarly, a half rotation starting from data point 505 horizontally to the left causes the cube display the data point (Fuji, David) 510 that has x-coordinates two units greater than 505. Similarly, the rotation of the cube to the right causes the cube to display information associated with data points with smaller x-coordinate values. FIG. 6(a) illustrates how the cube 105 can be rotated horizontally. The cube 600 in the process of being rotated may display partial information related to two data points with adjacent x-coordinates since two faces 620 and 625 may be displayed during the rotation. When the rotation is stopped, the front face of the cube 605 primarily displays information related to single data point as illustrated in FIG. 6(b). Note that depending on the context of the information being displayed, horizontal or vertical rotation does not always make sense—for example, it makes logical sense to rotate the cube to select a country—the United States on face 605, Canada on face 625, etc. Conversely, if the data displayed on face 605 is at a lower level in a hierarchy, for example the state of Michigan, it may not make logical sense to rotate horizontally to see a Canadian province, which is hierarchically equivalent to a US state. For that reason, in one embodiment the implementer has the option to disable or enable vertical or horizontal rotation for various data records.

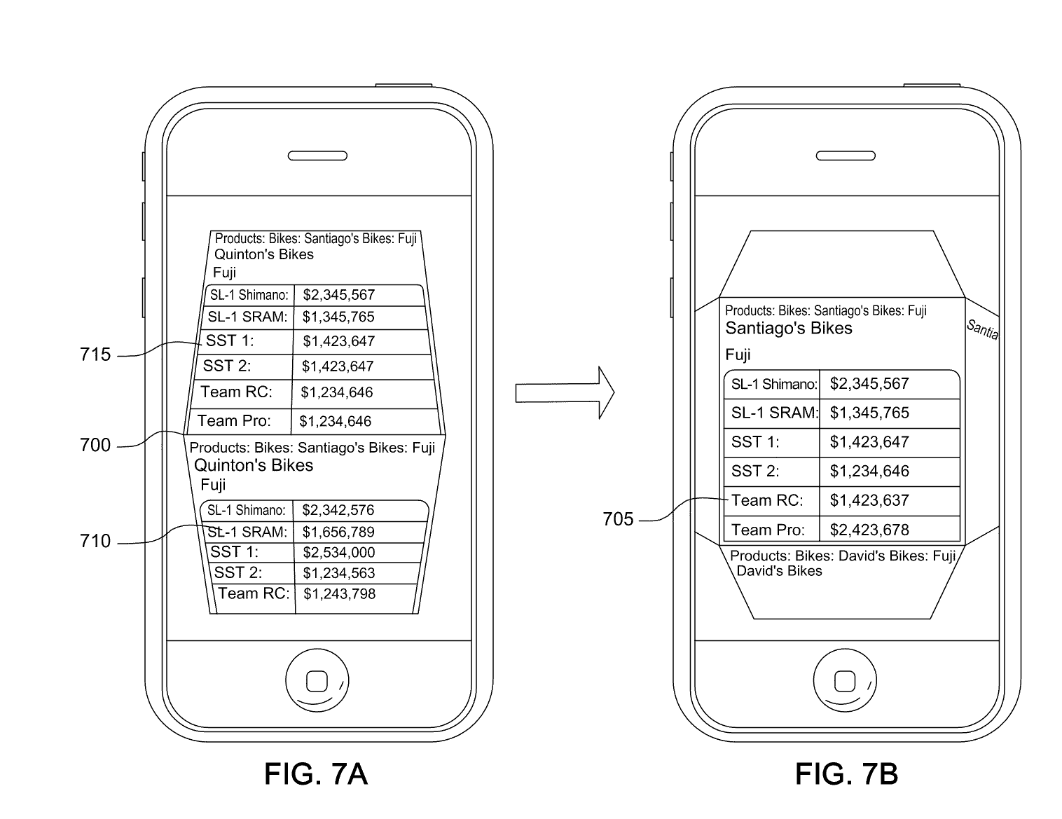

Referring again to FIG. 5, the cube displaying information related to data point 510 associated with coordinates (Fuji, David) can be rotated vertically downwards to display information associated with data points with higher y-coordinate values. For example, rotation of the cube vertically downwards causes the cube to display information related to data point (Fuji, Quinton) 540, (Fuji, John) 545, and (Fuji, Santiago) 515 depending on the amount of rotation. The rotation of the cube vertically upwards causes the cube to display data points with lower y-coordinate values. The user can interleave rotations in various directions causing the cube to display any data point of the chart. FIG. 7(a) illustrates how the cube 605 displayed in FIG. 6(b) can be rotated vertically to display information related to a data point with a different y-coordinate value. The cube 700 in the process of being rotated may display partial information related to two data points with adjacent y-coordinates since two faces 710 and 715 may be displayed during the rotation. When the rotation is stopped, the front face of the cube 705 primarily displays information related to a single data point as illustrated in FIG. 7(b).

In some embodiments, if the user input causing the rotation of the cube leaves the cube in a position displaying two partial front faces as shown in FIG. 6(a) or FIG. 7(a), the cube is continued to be rotated automatically in its current direction of rotation until a front face is fully displayed as shown in FIG. 6(b) or FIG. 7(b). Alternatively, if the user input causing the rotation of the cube leaves the cube in a position displaying two partial front faces, the cube is automatically rotated in the direction that causes the face displaying larger area to become the front face. The cube may be displayed as wiggling or vibrating before it comes to a complete halt similar to a spring coming to a halt after being released from tension.

In different embodiments, the change in the coordinate values of the data point based on the amount of rotation of the cube may vary. For example, a half rotation of the cube may result in a change of a single unit value along a coordinate. In some embodiments the cube can display information related to a set of data points and the rotation causes information related to the next set of data points to be displayed based on changes in the coordinate values. In some embodiments, the relation between the direction of rotation of the cube and the change in the coordinate values is the reverse of the description provided above. For example, the rotation of the cube horizontally towards right may cause the x-coordinate value to increase whereas the rotation horizontally towards left may cause the x-coordinate value to decrease.

The cube is a simulated object. Hence, after a full rotation of the simulated cube along a direction, the data displayed on the front face of a simulated cube may not be the data set displayed on the front face when the rotation started. A physical cube on the other hand displays the first face again after completing a full rotation. As shown in FIG. 5, if the cube is rotated horizontally towards right starting from the data set (Mongoose, David), the fifth face displayed after a full rotation shows the data set (Hero, David) which is different from the initial data set (Mongoose, David). For a large data set, the rotation of the cube along any dimension keeps displaying new data sets until the data sets are exhausted in the direction of rotation.

In some embodiments, if the rotation of the cube in a direction causes a coordinate value to be increased beyond the maximum coordinate values of the chart, the cube wraps around to the minimum coordinate value. For example, if the cube is associated with the maximum x-coordinate value Hero in FIG. 5, rotation of the cube horizontally towards right causes the cube to be associated with a data point with the minimum x-coordinate value Mongoose. Similarly, if the cube is displaying the data point with maximum y-coordinate value Joel, rotation of the cube vertically upwards causes the cube to display the data point with the minimum y-coordinate value David. Also, if the cube is displaying the data point with the minimum x-coordinate value Mongoose, rotating the cube horizontally towards left causes the cube to display the data point with maximum x-coordinate value of Hero. Similarly, if the cube is displaying the data point with minimum y-coordinate value David, rotation of the cube vertically downwards causes the cube to display the data point with the maximum y-coordinate value Joel.

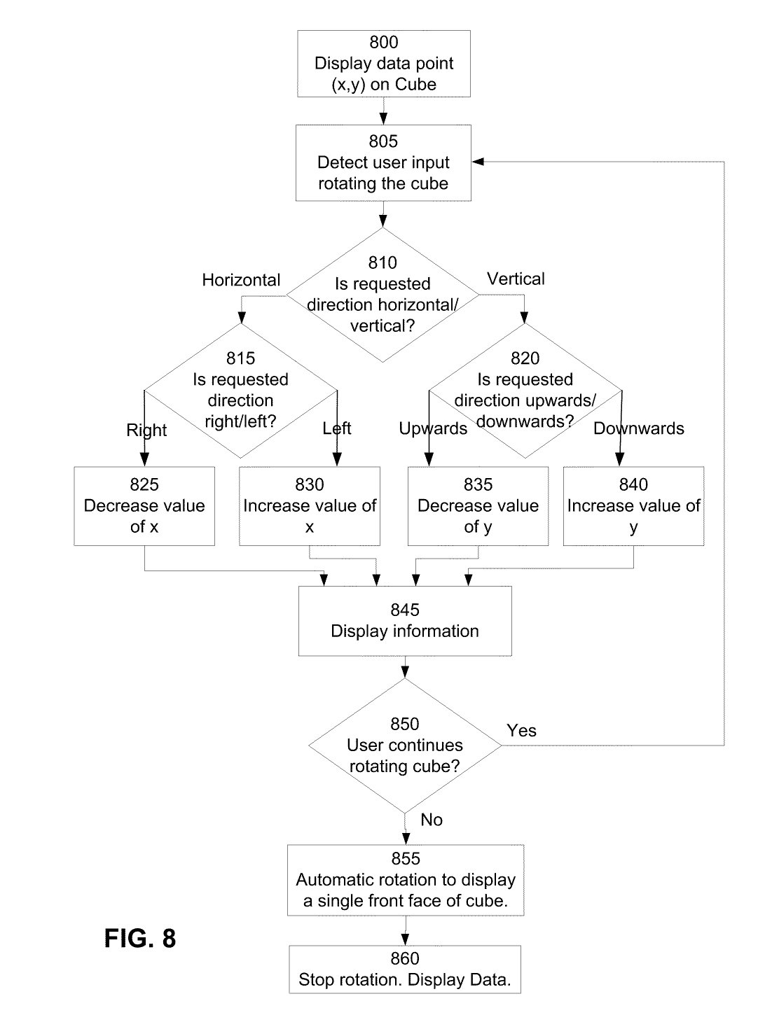

FIG. 8 shows a flowchart illustrating the various steps associated with the rotation of the cube and the corresponding determination of a data point to be displayed. The cube 105 displays 800 information related to data point associated with coordinates (x, y). The input/output driver 225 detects 805 user input specifying rotation of the cube. A determination 810 is made as to whether the rotation of the cube is vertical or horizontal. If the cube is rotated horizontally, further determination 815 is made whether the direction of rotation is left or right. Similarly if the cube is rotated vertically, further determination 820 is made whether the direction of rotation is upwards or downwards. A new set of coordinates are determined based on the detected direction of rotation, for example, if the direction of rotation is horizontal towards right, the value of x is decreased 825 and if the direction of rotation is horizontal towards right, the value of x is increased 830. Similarly, if the direction of rotation is vertical upwards, the value of y is decreased 835 and if the direction of rotation is vertical downwards, the value of y is increased 840. In an embodiment, the amount of change in the coordinate values as the coordinates are increased 830, 840 or decreased 825, 835 may depend on the user input, for example, the speed with which the user rotates the cube or the force with which the user rotates the cube. Larger the force or the speed indicated by the user input, the bigger is the change in the coordinate values. As the cube rotates, information related to data points based on the new values of the coordinates (x,y) is displayed 845. In some embodiments, audio feedback may be provided with the display of each new data point. As long as the user continues 850 rotating the cube, the coordinate values are recomputed and the corresponding data point displayed. When the user stops rotating the cube, the cube may be automatically rotated 855 to display a single face in the front, for example as shown in FIG. 1. Subsequently, the data associated with the last set of coordinates calculated is displayed and the rotation stopped 860.

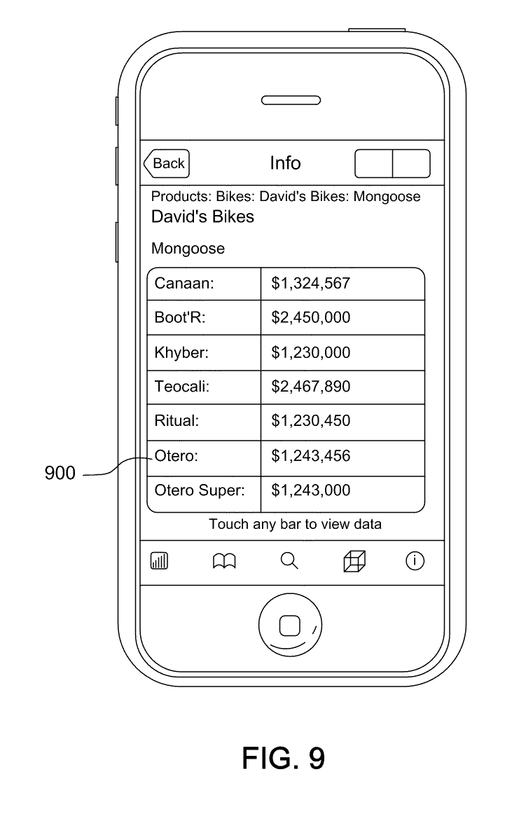

In some embodiments, once the cube is used to reach a particular data point, the display can be converted to a data inspection mode that does not display the cube, as shown in FIG. 9. The data inspection mode may allow better display of data 900 since there is larger display area available. Also, the user input that causes rotation of the cube in the mode that displays the cube can be interpreted in a different manner in the mode that does not display the cube, for example to allow the user to scroll through data that may not fit on the screen. The user can switch between the data inspection mode of display shown in FIG. 9 and a mode that displays the cube thereby allowing the user to change the data point being displayed in the data inspection mode, for example as shown in FIG. 1.

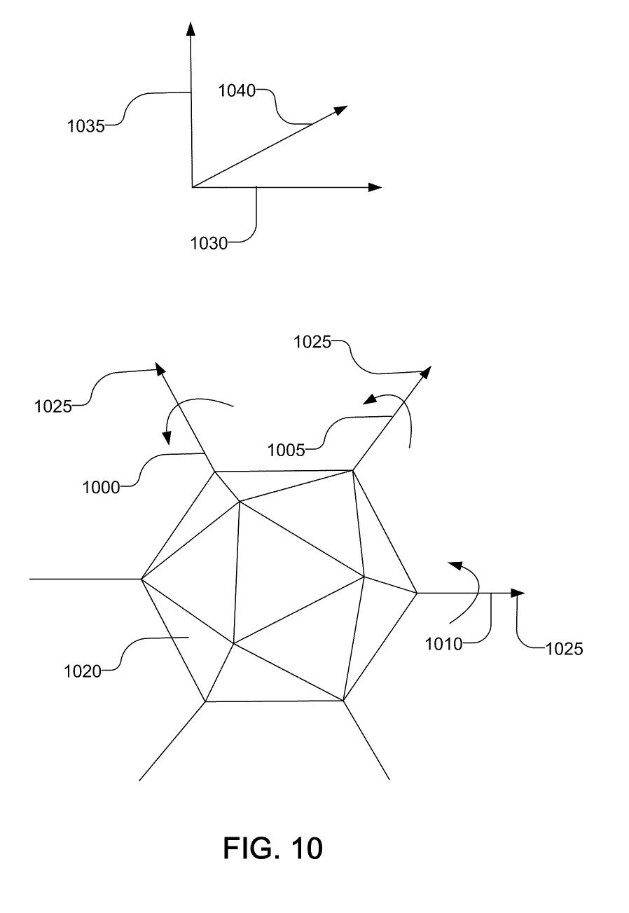

Other three dimensional objects may be displayed and associated with multi-dimensional charts. For example FIG. 10 shows a diamond shaped three-dimensional object 1020 that can be rotated along three different rotational axes 1000, 1005, and 1010. Similar objects can be used to present data related to three dimensional charts where the rotation along each axis 1000, 1005, and 1010 corresponds to movement along an axis of the chart. For example, rotation along 1000 axis can be associated with movement along x-axis 1030 of the chart, rotation along 1010 axis associated with movement along the y-axis 1035 of the chart and movement along the 1005 axis may be associated with the z-axis 1040 of the chart. Along each rotational axis the object 1020 can be rotated either clockwise or counterclockwise as viewed by an observer at the top of the axis close to the side displaying the arrow 1025. The clockwise rotation may be associated with increase of the coordinate values whereas the counterclockwise rotation may be associated with a decrease in the coordinate value of the data point for which information is displayed (alternatively the direction of rotation may be associated with the opposite change of coordinate values). Similarly a circular object can be used to present data associated with multi-dimensional charts including two-dimensional, three dimensional, or higher dimensional charts.

The cube can be viewed as an object with linear motion along the data points of the chart, displaying information associated with data points encountered on the chart as the cube moves. The cube can be used to inspect data points of small chart but can be adapted to inspect data points of large charts as well. For example, in one embodiment, the user is allowed to configure the distance traversed by the cube with a single rotation. For example, if a quarter rotation of the cube causes the cube to display an adjacent data point, a full rotation causes the cube to display a data point that is distance four away from the original data point along a dimension. However, if the cube can be reconfigured to move, for example, sixteen data points with one rotation, the cube can be rotated to travel much faster along the chart. When the cube is rotated to reach close to the destination data point, the cube can be reconfigured to travel slowly such that it moves four data points with a full rotation.

In some embodiments, the user can switch to a viewing mode that displays the entire set of data points or a subset of the data points of the reports. In this report viewing mode, the user is allowed to make a selection that determines the data point associated with the cube. Once the cube is associated with the data point, the user can use cube rotation to navigate to other data points from the selected data points. The user can switch back and forth between the cube navigation mode and the report display mode to make the navigation through large reports efficient.

It is to be understood that the Figures and descriptions of the present invention have been simplified to illustrate elements that are relevant for a clear understanding of the present invention, while eliminating, for the purpose of clarity, many other elements found in a typical system that allows users to view report data. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Some portions of above description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for displaying data points of a chart using a rotating object through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

We claim:

1. A computer implemented method of displaying multi-dimensional data on a display screen, the method comprising:
displaying a rotatable cube in a first orientation on the display screen, at least a first side of the cube visible in the first orientation and including a first subset of the multi-dimensional data; and
responsive to receiving user input specifying a rotation of the cube, rotating the cube into a second orientation, at least a second side of the cube visible in the second orientation and including a second subset of the multi-dimensional data, the second subset of multi-dimensional data including data points located along one of the dimensions of the data displayed in the first subset of multi-dimensional data.

2. The method of claim 1, wherein a speed of rotation of the cube is determined by the user input.

3. The method of claim 1 wherein the cube can be rotated along a vertical direction and a horizontal direction.

4. The method of claim 1, wherein the user input includes a swiping gesture across the cube.

5. The method of claim 4, wherein a rate at which the cube is rotated is dependent at least in part upon the speed with which the user swipes across the cube.

6. The method of claim 1, wherein the user input includes physically tilting the display screen.

7. The method of claim 6, wherein a rate at which the cube is rotated is dependent at least in part upon the degree of tilt of the display screen.

8. The method of claim 1, wherein audio feedback is provided as the cube is rotated each time information displayed related to data points is changed.

9. The method of claim 1, wherein a distance between a first point of the first subset and a second point of the second subset along a first dimension from the plurality of dimensions is determined based on an amount of rotation of the cube along a predetermined axis of rotation.

10. The method of claim 1, wherein a sign of a difference of coordinate value of a first point in the first subset and a second point in the second subset is determined by a direction of rotation of the cube along a predetermined axis of rotation.

11. The method of claim 1, wherein the multi-dimensional data is associated with an x-axis and a y-axis, the rotation of the cube is horizontal, and points in the first subset and points in the second subset differ in x-coordinate values.

12. The method of claim 1, wherein the multi-dimensional data is associated with an x-axis and a y-axis, the rotation of the cube is vertical, and points in the first subset and points in the second subset differ in y-coordinate values.

13. The method of claim 1, wherein the multi-dimensional data is associated with an axis with a low limit and a high limit and rotation of the cube below the low limit causes the cube to wrap around to display a data point at the high limit and rotation of the cube above the high limit causes the cube to display a data point at the low limit.

14. The method of claim 1, further comprising:
displaying a subset of data points of the report; and
responsive to a selection by the user, determining the first data point.

15. A computer implemented method of displaying multi-dimensional data on a display screen with limited display area, the method comprising:
displaying a rotatable three-dimensional object in a first orientation on the display screen, at least a first side of the three-dimensional object visible in the first orientation and including a first subset of the multi-dimensional data; and
responsive to receiving user input specifying a rotation of the three-dimensional object, displaying the three dimensional object rotating into a second orientation, at least a second side of the three dimensional object visible in the second orientation and including a second subset of the multi-dimensional data, the second subset of multi-dimensional data including data points located along one of the dimensions of the data displayed in the first subset of multi-dimensional data.

16. The method of claim 15, wherein a speed of rotation of the three-dimensional object is determined by the user input.

17. The method of claim 15, wherein the user input includes a swiping gesture across the three-dimensional object.

18. The method of claim 17, wherein a rate at which the three-dimensional object is rotated is dependent at least in part upon the speed with which the user swipes across the three-dimensional object.

19. A system for displaying multi-dimensional data on a display screen with limited display area, the system comprising:
a computer processor; and
a computer-readable storage medium storing computer program modules configured to execute on the computer processor, the computer program modules comprising:
an input/output driver module configured to:
display a rotatable cube in a first orientation on the display screen, at least a first side of the cube visible in the first orientation and including a first subset of the multi-dimensional data; and
responsive to receiving user input specifying a rotation of the cube, rotate the cube into a second orientation, at least a second side of the cube visible in the second orientation and including a second subset of the multi-dimensional data, the second subset of multi-dimensional data including data points located along one of the dimensions of the data displayed in the first subset of multi-dimensional data.

20. A computer program product having a computer-readable storage medium storing computer-executable code for displaying multi-dimensional data on a display screen with limited display area, the code comprising:
an input/output driver module configured to:
display a rotatable cube in a first orientation on the display screen, at least a first side of the cube visible in the first orientation and including a first subset of the multi-dimensional data; and
responsive to receiving user input specifying a rotation of the cube, rotate the cube into a second orientation, at least a second side of the cube visible in the second orientation and including a second subset of the multi-dimensional data, the second subset of multi-dimensional data including data points located along one of the dimensions of the data displayed in the first subset of multi-dimensional data.
